(19) United States
(12) Patent Application Publication
(10) Pub. No.: US 2019/0350218 A1
(43) Pub. Date: Nov. 21, 2019

(54) HEALTHY FOOD PRODUCTS AND METHODS

(71) Applicant: Ian Schenkel, Ontario, CA (US)

(72) Inventor: Ian Schenkel, Ontario, CA (US)

(21) Appl. No.: 16/414,225

(22) Filed: May 16, 2019

Related U.S. Application Data
(60) Provisional application No. 62/672,771, filed on May 17, 2018.

(51) Int. Cl. A23D 7/00; A23D 7/02; A23L 27/60; A23L 27/10; A23L 27/14; A23L 11/00

(52) U.S. Cl. CPC A23D 7/001; A23D 7/02; A23L 27/60; A23L 27/105; A23V 2300/38; A23L 11/07; A23V 2002/00; A23V 2300/26; A23L 27/14

(57) ABSTRACT

Pulses are used to produce low-fat, low-calorie, high viscosity food products having superior texture, preferably without need for added emulsifiers and stabilizers. Generally, the food products are made by hydrating pulses (seeds), milling or pulverizing the pulses before, during or after hydration, and then homogenizing the hydrated pulses with additional liquid at temperatures between 0 and 121° C. and pressures between 6.9 and 690 MPa. Additional liquid is advantageously added before or during homogenization to achieve a liquid:solid ratio of between 2:1 and 15:1, depending on the desired end products. The emulsions produced by these conditions preferably have low lipid content and high viscosity, because of the small hydrodynamic particle size (5-200 μm). Flavorings can be added to the emulsions to make commercial products that can be packaged as mayonnaise, salad dressings, food spreads and dips, etc.

This application claims priority to U.S. Provisional Patent Application No. 62/672,771, filed on May 17, 2018, which is incorporated herein by reference in its entirety.

### FIELD OF THE INVENTION

The field of the invention is healthy food products and methods. Specifically, food products are made with pulses, preferably with minimal or no added fats or oils, emulsifiers, or animal products.

### BACKGROUND

The background description includes information that may be useful in understanding the present inventive subject matter. It is not an admission that any of the information provided herein is prior art or relevant to the presently claimed inventive subject matter, or that any publication specifically or implicitly referenced is prior art.

A healthy diet is increasingly recognized to play an important role in maintaining good health, including weight control and disease prevention. As a result, many consumers prefer a low-calorie, plant-based food product, and consider foods with relatively high fat content to be undesirable. Dairy products (e.g., whey, sour cream) are also thought by some to be undesirable due to increased risk of certain diseases, including cancer and allergies.

Pulses are often regarded as a good candidate for making healthy food products, due to their low-glycemic index and potential health enhancing qualities. They can be an excellent source for certain minerals (including calcium, iron, phosphorus, potassium, and zinc), dietary fiber, vitamins, and amino acids. There is evidence to suggest that consumption of some pulses can reduce cholesterol levels, heart disease, diabetes, obesity, certain cancers and inflammation of the digestive system.

Since pulses are relatively high in protein and oil contents, conventional processing of pulses into a stable emulsion is difficult without adding animal-based or artificial emulsifiers (e.g., egg yolk or whole egg, as disclosed in US2012034353, by Eggeling, et al.). Pulse-based emulsion products made under ordinary conditions, i.e., normal pressure and temperature, perhaps with a blender or food processor, are also problematic because they tend to lack satisfactory texture (e.g., sheen and mouth-feel).

Thus, there is a need for pulse-based food products that are stable enough for commercialization, have superior sheen and mouth-feel, and are preferably made with minimal or no added fats or oils, emulsifiers, or animal products.

Eggeling and all other publications herein are incorporated by reference to the same extent as if each individual publication or patent application were specifically and individually indicated to be incorporated by reference. Where a definition or use of a term in an incorporated reference is inconsistent or contrary to the definition of that term provided herein, the definition of that term provided herein applies and the definition of that term in the reference does not apply.

### SUMMARY OF THE INVENTION

The inventive subject matter provides apparatus, systems and methods in which pulses are used to produce low-fat, low-calorie, high viscosity food products having superior texture, preferably without need for added emulsifiers and stabilizers.

In general, the food products are made by hydrating pulses (seeds), milling or pulverizing the pulses before, during or after hydration and then homogenizing the hydrated pulses with additional liquid at high pressure.

The process preferably starts with dried pulses having with 3-12% water content. The hydrating liquid is preferably at least 95 wt % water. Currently preferred pulses are soybeans and white beans because they are readily available and relatively inexpensive.

Homogenization preferably occurs at temperatures of between 32 and 250 Fahrenheit, i.e., between 0 and 121 degrees Celsius (° C.). Experimentation has shown that optimal pressures are likely between 3,000 psi (2.0684×10⁷ Pascal) and 15,000 psi (1.0342×10⁸ Pascal), and more preferably between 5,000 psi (3.4474×10⁷ Pascal) and 10,000 psi (6.8948×10⁷ Pascal). Lower pressures tend to produce products with unsatisfactory mouth feel, and higher pressures are unnecessary.

Homogenization preferably also occurs at pressures between 1,000 psi (6.895×10⁶ Pascal) and 100,000 psi (6.895×10⁸ Pascal). Optimal temperatures are likely between 40 Fahrenheit (4.44° C.) and 210 Fahrenheit (98.89° C.), and more preferably between 40 Fahrenheit (4.44° C.) and 125 Fahrenheit (51.67° C.). Lower pressures tend to produce products with unsatisfactory mouth feel, and higher pressures tend to increase viscosity dramatically.

Additional liquid is advantageously added before or during homogenization to achieve a liquid:solid ratio of between 2:1 and 15:1, depending on the desired end products. For mayonnaise type products, for example, the desired liquid:solid ratio is typically between 2:1 and 5:1. For salad dressings, for example, the desired liquid:solid ratio is typically between 3:1 and 6:1.

Since the food products are intended to be low fat, the emulsions produced by the conditions specified above preferably has a lipid content of no more than 10 wt %, and more preferably no more than 6 wt %. And to satisfy consumer demand for palatability, preferred products have a high viscosity, at least 10,000 centipoise (cps) as determined by a Brookfield rotational viscometer at STP (20° C. and atmospheric pressure). These seemingly conflicting characteristics are produced by the conditions specified above, because they yield relatively thick emulsions having average hydrodynamic particle size of between 5 micron (μm) and 200 micron (μm), inclusive, as determined according to ISO 22412:2017.

Depending on the pulses utilized, the emulsions described above will be very bland without additional flavorings. It is thus contemplated that commercially viable products will also include one or more of vinegar, salt, and flavorings. Contemplated flavorings include garlic powder, onion powder, or other herbs. Contemplated commercial products can alternatively or additionally include a nutritional fortifier to enhance the nutritional profile of the food products, for example, powdered quinoa or other high protein grain.

As modified above, contemplated commercial products can be packaged as mayonnaise, salad dressings, food spreads and dips. Because of the blandness of the intermediate emulsions, recipes can be readily customized for different restaurants, brands, and so forth. Also, even though products contemplated herein do not need added oil, animal products, or emulsifiers to be commercially acceptable, it is contemplated that these or other additives could be included to satisfy demands of particular customers.

### BRIEF DESCRIPTION OF THE DRAWING

FIG. 1 is a flowchart generally illustrating the preparation of a healthy food product using the method of the present invention.

FIG. 2 shows the steps in an example of preparing healthy food products using the method of the present invention.

### DETAILED DESCRIPTION

The present invention relates to 1) pulse-based food products with superior mouth feel and sheen and 2) methods for making such a food product.

The following discussion provides many example embodiments of the inventive subject matter. Although each embodiment represents a single combination of inventive elements, the inventive subject matter is considered to include all possible combinations of the disclosed elements. Thus if one embodiment comprises elements A, B, and C, and a second embodiment comprises elements B and D, then the inventive subject matter is also considered to include other remaining combinations of A, B, C, or D, even if not explicitly disclosed.

As used in the description herein and throughout the claims that follow, the meaning of “a,” “an,” and “the” includes plural reference unless the context clearly dictates otherwise. Also, as used in the description herein, the meaning of “in” includes “in” and “on” unless the context clearly dictates otherwise.

Unless the context dictates the contrary, all ranges set forth herein should be interpreted as being inclusive of their endpoints, and open-ended ranges should be interpreted to include only commercially practical values. Similarly, all lists of values should be considered as inclusive of intermediate values unless the context indicates the contrary.

In some embodiments, the numbers expressing quantities of ingredients, properties such as concentration, reaction conditions, and so forth, used to describe and claim certain embodiments of the invention are to be understood as being modified in some instances by the term “about.” Accordingly, in some embodiments, the numerical parameters set forth in the written description and attached claims are approximations that can vary depending upon the desired properties sought to be obtained by a particular embodiment. In some embodiments, the numerical parameters should be construed in light of the number of reported significant digits and by applying ordinary rounding techniques. Notwithstanding that the numerical ranges and parameters setting forth the broad scope of some embodiments of the invention are approximations, the numerical values set forth in the specific examples are reported as precisely as practicable. The numerical values presented in some embodiments of the invention may contain certain errors necessarily resulting from the standard deviation found in their respective testing measurements.

The recitation of ranges of values herein is merely intended to serve as a shorthand method of referring individually to each separate value falling within the range. Unless otherwise indicated herein, each individual value is incorporated into the specification as if it were individually recited herein. All methods described herein can be performed in any suitable order unless otherwise indicated herein or otherwise clearly contradicted by context. The use of any and all examples, or exemplary language (e.g. “such as”) provided with respect to certain embodiments herein is intended merely to better illuminate the invention and does not pose a limitation on the scope of the invention otherwise claimed. No language in the specification should be construed as indicating any non-claimed element essential to the practice of the invention.

Groupings of alternative elements or embodiments of the invention disclosed herein are not to be construed as limitations. Each group member can be referred to and claimed individually or in any combination with other members of the group or other elements found herein. One or more members of a group can be included in, or deleted from, a group for reasons of convenience and/or patentability. When any such inclusion or deletion occurs, the specification is herein deemed to contain the group as modified thus fulfilling the written description of all Markush groups used in the appended claims.

As used herein, the terms “pulse” and “pulses” mean any of the following edible seeds, and related hybrids: adzuki beans, azuki beans, bambara beans, Bengal gram, black gram, black-eyed beans, black-eyed peas, broad beans, butter beans, Cajan peas, chick peas, Cici beans, Congo beans, cow peas, cowitch, faba beans, field beans, field peas, gandules, garden peas, golden gram, green gram, Habas beans, haricot beans, hyacinth beans, jack beans, kidney beans, lentils, lima beans, lupins, moth beans, mung beans, navy beans, peanuts, pigeon peas, pinto beans, rice beans, scarlet runner beans, soybeans, sword beans, tepary beans, urad, velvet beans, vetches, white beans, winged beans, and yam beans.

Also as used herein, the term “pulse plant” means any plant that produces pulse (seeds).

Pulses contemplated for use according to the inventive subject matter are not limited to any particular level of maturity, hydration, or germination. As such pulses includes seeds that are harvested while still green, as well as those harvested when more mature. Similarly, pulses contemplated for use according to the inventive subject matter also include pulses that are spouted, either naturally or artificially. In preferred embodiments, however, dried pulses with a water-content of between 3 and 12%, inclusive, are stored, hydrated, milled or pulverized before, during or after hydration and then homogenized.

As used herein, the term “organic” means food produced without employment of chemically formulated fertilizers, growth stimulants, antibiotics, or pesticides, without being exposed to any residues of those aforementioned chemically formulated products, and without use of genetic engineering or genetically modified organisms (GMOs).

As used herein, the term “as determined by the weight” means measuring the weight of an ingredient then divided by the weight of the food composition with all the ingredients in it, including any liquid.

Pulses can be hydrated by mixing, immersing, or submerging pulses with a liquid. Preferred embodiments use water (e.g., tap water, spring water, purified water, or deionized water). Some embodiments can use water supplemented with minerals, flavors, spices, or other substances. Contemplated liquid include soy sauce, vinegar, cooking wine, etc.

Hydrating is preferably accomplished in batches, although it is contemplated that hydrating could occur using a conveyor, or using some other continuous basis.

Pulses can be hydrated at any suitable temperature (e.g., room temperature, above the room temperature, or below room temperature) and at normal atmospheric pressure. It is contemplated that the time required for hydration would be shorter at a higher temperature compared that required at a lower temperature.

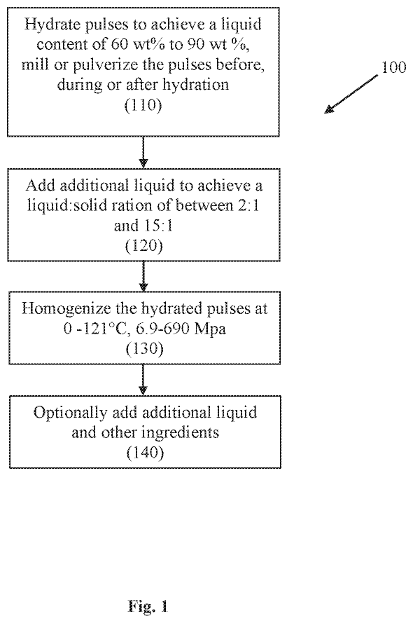

FIG. 1 generally depicts steps 100 in producing a food product. In step 110, pulses are hydrated to achieve a water content of between 60 wt % and 90% wt %, inclusive, and milled or pulverized before, during or after hydration. In especially preferred embodiments, pulses are milled then super-hydrated to achieve a water content of between 65% and 85%, inclusive.

Preferred pulses are soybeans and white beans, although any of the listed pulses could be used, or any combination thereof. Where different types of pulses are used, the different types can be hydrated together or separately.

In step 120, additional liquid is added to the hydrated seeds to achieve a liquid:solid ratio of between 2:1 and 15:1, inclusive. In especially preferred embodiments, the liquid:solid ratio is between 2:1 and 6:1.

In step 130, homogenization can be achieved by any suitable homogenizer, including for example the homogenizer taught in U.S. Pat. No. 8,962,056 (Succar et al.). The hydrated seeds and liquid are homogenized at a temperature between 32° F. (0° C.) and 250° F. (121.1° C.), inclusive, and a pressure between 1,000 psi (6.90×10⁶ Pascal) and 100,000 psi (6.90×10⁸ Pascal), inclusive. In especially preferred embodiments, hydrated seeds are homogenized at a temperature between 40° F. (4.44° C.) and 125° F. (51.67° C.), inclusive, and a pressure between 5,000 psi (3.4474×10⁷ Pascal) and 15,000 psi (1.0342×10⁸ Pascal), inclusive. It is contemplated that increased pressure leads to decreased throughput and greater viscosity.

In preferred embodiments, high-pressure homogenization of the mixture of pulses and water will result in an emulsion of pulses and a liquid, having an average hydrodynamic particle size of between 5 micron (μm) and 200 micron (μm), inclusive, as determined according to ISO 22412:2017.

In some embodiments, the emulsion has a viscosity of at least 10,000 centipoise (cps), as determined by a Brookfield rotational viscometer (e.g., RV-Series viscometer with TCD spindle at 4 rpm) at STP (20° C. and atmospheric pressure) within 5 minutes after homogenization.

In step 140, it is further contemplated that other ingredients can be added to the pulses, before, during, or after the step of hydration or the step of homogenization. Contemplated ingredients include vinegar, salt, and flavorings. Contemplated flavorings include garlic powder, onion powder, chili powder, pepper powder, turmeric powder, or an herb. Contemplated herbs include rosemary, basil, mint, oregano and thyme, cilantro, and parsley. In some embodiments, one or more nutritional fortifiers are added to the homogenized pulses. Contemplated nutritional fortifiers include seeds (e.g., brown rice, corn, quinoa, chia, etc). Contemplated nutritional fortifiers may also include minerals, vitamins, dietary fiber, and amino acids.

Although not required, an emulsifier, stabilizer, preservative or other additive, or even additional liquid, can be added at any step, or between steps. Depending on how much water (or other liquid) is added, the final product could be any of numerous products, including for example a mayonnaise, a salad dressing, a spread, or a dip.

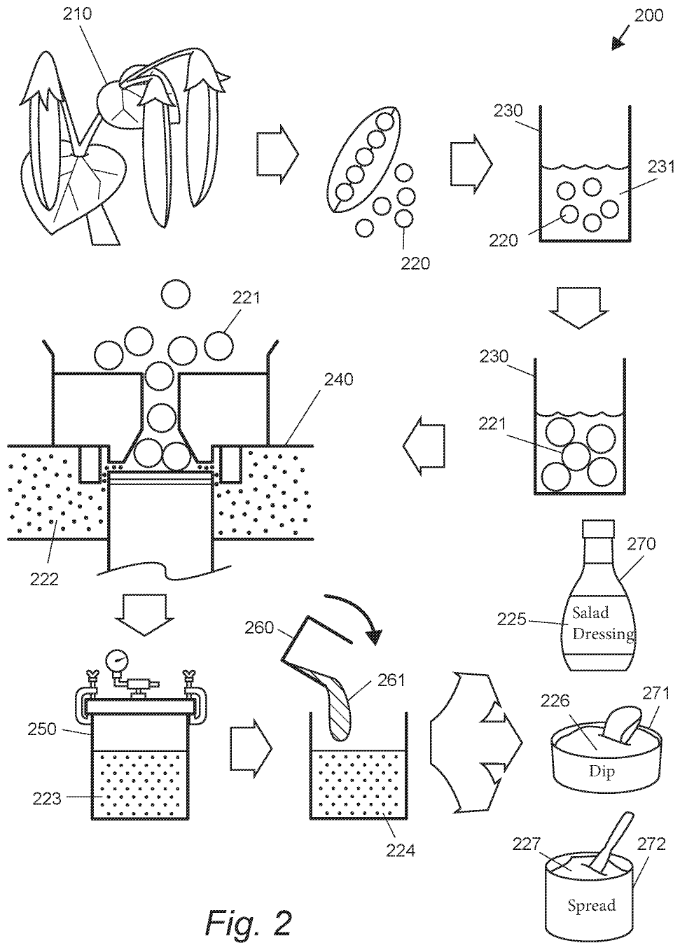

FIG. 2 shows the steps in an example of preparing healthy food products using the method of the present invention. In FIG. 2, seeds (220) of a pulse plant (210) are harvested and hydrated in a liquid (231) to achieve a preferred liquid content of between 60% and 90%. It can be observed that the hydrated seeds (221) are bigger in size compared to seeds (220) before hydration. The hydrated seeds (221) are pulverized through a pulverizer (240). Additional liquid is added before or during homogenization to achieve a liquid:solid ratio of between 2:1 and 15:1, depending on the desired end products. The pulverized seeds (222) are then homogenized with a liquid in a homogenizer (250). An additional amount of liquid (261) and flavoring (e.g., garlic powder, an onion powder, a chili powder, a pepper powder, and vinegar) and an optional nutritional fortifier are added to the homogenized seeds (223), to make a desired food composition (224). The desired end products can be a salad dressing (225), a spread (227), or a dip (226). Each final product can be labeled as such on its container. The container (270) for the salad dressing (225) is labeled as salad dressing. The container (271) for the dip (226) is labeled as a dip. The container (272) for the spread (227) is labeled as a spread.

It should be apparent to those skilled in the art that many more modifications besides those already described are possible without departing from the inventive concepts herein. The inventive subject matter, therefore, is not to be restricted except in the spirit of the appended claims. Moreover, in interpreting both the specification and the claims, all terms should be interpreted in the broadest possible manner consistent with the context. In particular, the terms “comprises” and “comprising” should be interpreted as referring to elements, components, or steps in a non-exclusive manner, indicating that the referenced elements, components, or steps may be present, or utilized, or combined with other elements, components, or steps that are not expressly referenced. Where the specification claims refers to at least one of something selected from the group consisting of A, B, C . . . and N, the text should be interpreted as requiring only one element from the group, not A plus N, or B plus N, etc.

What is claimed is:

1. A method for producing a food product, comprising:
hydrating seeds (220) of at least one type of a pulse plant (210) ;
milling or pulverizing the hydrated seeds (221), before, during or after hydration; and
homogenizing the milled or pulverized seeds (222) with a liquid, at a range of temperatures between 0° C. and 121° C., inclusive, and a range of pressures between 6.90 MPa and 690 MPa, inclusive.

2. The method of claim 1, further comprising hydrating the seeds (220) to achieve a liquid content of between 60% and 90%, inclusive.

3. The method of claim 1, further comprising adding at least one of: (a) an additional amount of the liquid; and (b) an amount of a different liquid, to the hydrated seeds (220) during the step of homogenizing to achieve a liquid:solid ratio of between 2:1 and 15:1, inclusive.

4. The method of claim 1, wherein the range of temperatures at which the hydrated seeds (221) are homogenized is between 4.44° C. and 51.67° C., inclusive.

5. The method of claim 1, wherein the range of pressures at which the hydrated seeds (221) are homogenized is between 3.4474×10⁷ Pascal and 1.0342×10⁸ Pascal, inclusive.

6. The method of claim 1, further comprising using soybeans as at least some of the seeds (220) being hydrated.

7. The method of claim 1, further comprising adding at least one of: (a) an additional amount of the liquid (261); and (b) an amount of a different liquid, after the step of homogenizing the seeds.

8. The method of claim 1, wherein the liquid is at least 98% water.

9. A food composition comprising an emulsion of: (a) seeds of at least one type of pulse plant (210); and (b) a liquid (231), having:
an average hydrodynamic particle size of between 5 micron (μm) and 200 micron (μm), inclusive, as determined according to ISO 22412:2017;
a lipid content of no more than 10 wt %; and
a viscosity of at least 10,000 centipoise (cps), as determined by a Brookfield rotational viscometer at STP (20° C. and atmospheric pressure).

10. The food composition in claim 9, wherein the average hydrodynamic particle size is between 5 micron (μm) and 160 micron (μm), inclusive.

11. The food composition in claim 9, wherein the average hydrodynamic particle size is between 5 micron (μm) and 100 micron (μm), inclusive.

12. The food composition in claim 9, wherein the lipid content is no more than 6 wt %.

13. The food composition in claim 9, wherein the viscosity is at least 20,000 centipoise (cps).

14. The food composition in claim 9, wherein the liquid (231) is at least 98% water.

15. The food composition in claim 9, further comprising at least one flavoring selected from the group consisting of a garlic powder, an onion powder, a chili powder, and a pepper powder.

16. The food composition in claim 9, further comprising a nutritional fortifier.

17. The food composition in claim 19, wherein the nutritional fortifier comprises an amount of quinoa.

18. The food composition in claim 9, further comprising an amount of vinegar.

19. The food composition in claim 9, wherein at least some of the seeds (220) are soybeans.

20. The food composition in claim 9, wherein the food composition is labeled on a container as one of the following: a salad dressing (270), a spread (272), or a dip (271).
